(19) United States
(12) Patent Application Publication
(10) Pub. No.: US 2008/0268912 A1
(43) Pub. Date: Oct. 30, 2008

(54) Wireless headphone

(75) Inventor: Cheng-Nan Wang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 12/068,723

(22) Filed: Feb. 11, 2008

(30) Foreign Application Priority Data
Apr. 27, 2007 (TW) 96114950

(51) Int. Cl. H04M 1/00; H04R 1/10

(52) U.S. Cl. 455/569.1; 381/370; 381/104

(57) ABSTRACT

A wireless headphone, such as a Bluetooth wireless headphone, includes a Bluetooth wireless module and a modulated module. The Bluetooth wireless module is configured to receive a Bluetooth communication signal and the modulated module is configured to receive a FM audio signal. The Bluetooth wireless module and the modulated module are electrically connected.

### BACKGROUND OF THE INVENTION

1. Field of the Invention

The invention relates to a wireless headphone and more in particular, to a wireless headphone with Bluetooth technology and integrated FM radio function.

2. Description of the Related Art

In recent years, with rapid advancement of wireless technology, different applications for wireless devices have expanded allowing users much convenience. With respect to multimedia applications, for example, a Bluetooth wireless headphone with wireless transmission eliminates the inconvenience of corded headphones and possible damage due to the pulling and dragging of cords, and thus becoming an essential device for many people today.

Referring to FIG. 1, a conventional Bluetooth headphone 1 may only receive audio signal through Bluetooth transmission technology, or receive a communication signal from a cellular phone p, making it inconvenient for the user in some situations. For example, if a user is mountain climbing or exercising and desires to listen to the radio for the weather report, in addition to a Bluetooth headphone 1, the user will be required to have a walkman w with a radio function. Thus, increasing weight carried by the mountain climber is inconvenient for use. Moreover, since the Bluetooth headphone 1 is unable to automatically switch the signal sources, the Bluetooth headphone 1 will turn off when the communication with cellular phone p is over or the Bluetooth headphone 1 is unable to receive the Bluetooth signal source. At which time, should the user desire to use the Bluetooth headphone 1, the user will be required to turn on the Bluetooth headphone 1 once again.

Consequently, there is a need for a wireless headphone with a simpler operating method, portability, and FM receiving function.

### BRIEF SUMMARY OF THE INVENTION

In order to solve the aforementioned problems, the invention provides a wireless headphone to facilitate the user to listen to FM audio signal without carrying additional devices and increasing costs.

In order to achieve the above-mentioned objectives, the invention provides a wireless headphone, wherein the wireless headphone includes a wireless module configured to receive a radio-communication signal, and a modulated module configured to receive a FM audio signal. Moreover, the wireless module and the modulated module are electrically connected.

Also, in order to achieve the aforementioned objectives, the invention provides a Bluetooth wireless headphone, wherein the Bluetooth wireless headphone includes a Bluetooth wireless module configured to receive a Bluetooth communication signal, and a modulated module configured to receive a FM audio signal. Further, the Bluetooth wireless module and the modulated module are electrically connected.

For both of the above, the wireless headphone and the Bluetooth wireless headphone further include an audio amplifier configured to adjust the volume thereof, and an audio switch configured to select a modulated Bluetooth communication signal or a FM audio signal. Further, the wireless module can control the switching of the modulated module, the audio amplifier and the audio switch through a programmable input/output (PIO) line. The wireless module can adjust the frequency of the modulated module and the volume of the audio amplifier through an inter-integrated circuit (I2C). In addition, the modulated module can share a micro-controller and a cache in the wireless module. Additionally, the wireless headphone further includes at least a button configured to control the wireless module, and a speaker connected with the modulated module through a wire, which is configured as an antenna of the modulated module.

In addition, the Bluetooth wireless headphone further includes a microphone configured to answer an external call, wherein the Bluetooth wireless headphone may be paired with a device having a wireless transmission function, such as a cellular phone or a walkman.

Further scope of the applicability of the present invention will be apparent from the detailed description given hereinafter. However, it should be understood that the detailed description and specific examples, while indicating preferred embodiments of the present invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the subsequent detailed description and the accompanying drawings, which are given by way of illustration only, and thus are not limitative of the present invention, and wherein:

FIG. 1 is a schematic diagram of a conventional Bluetooth headphone;

FIG. 2 is a schematic diagram of a wireless headphone according to an embodiment of the invention;

FIG. 3A is a block diagram illustrating the switch function of the wireless headphone shown in FIG. 2;

FIG. 3B is a block diagram illustrating the FM function of the wireless headphone shown in FIG. 2;

FIG. 4A is a descriptive drawing indicating the button function in the Bluetooth mode employed by the wireless headphone shown in FIG. 2; and

FIG. 4B is a descriptive drawing indicating the button function in the FM mode employed by the wireless headphone shown in FIG. 2.

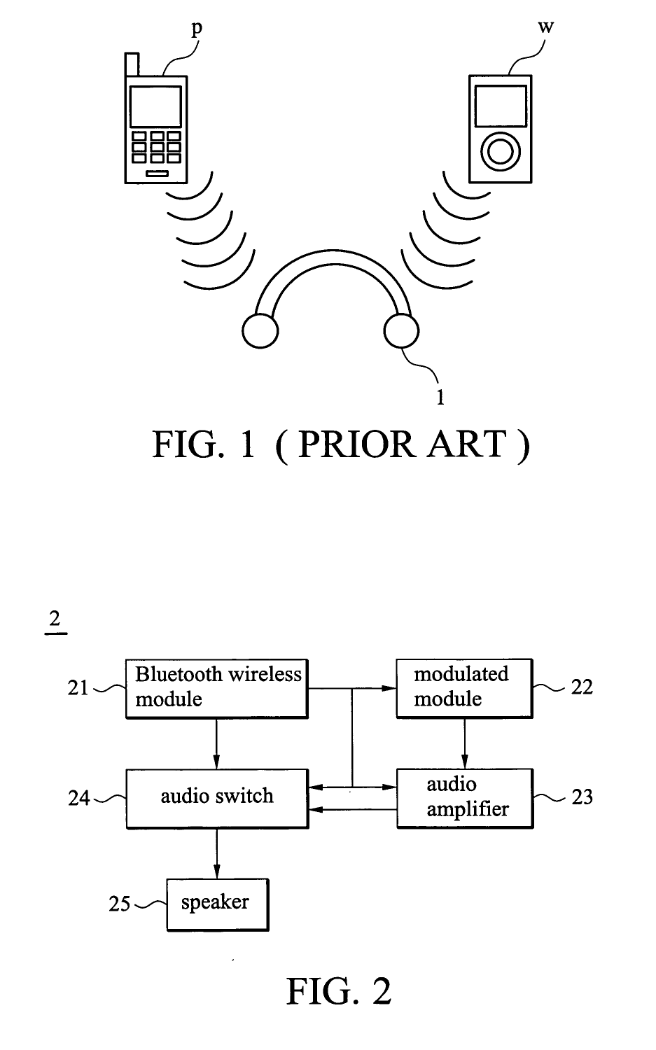

### DETAILED DESCRIPTION OF THE INVENTION

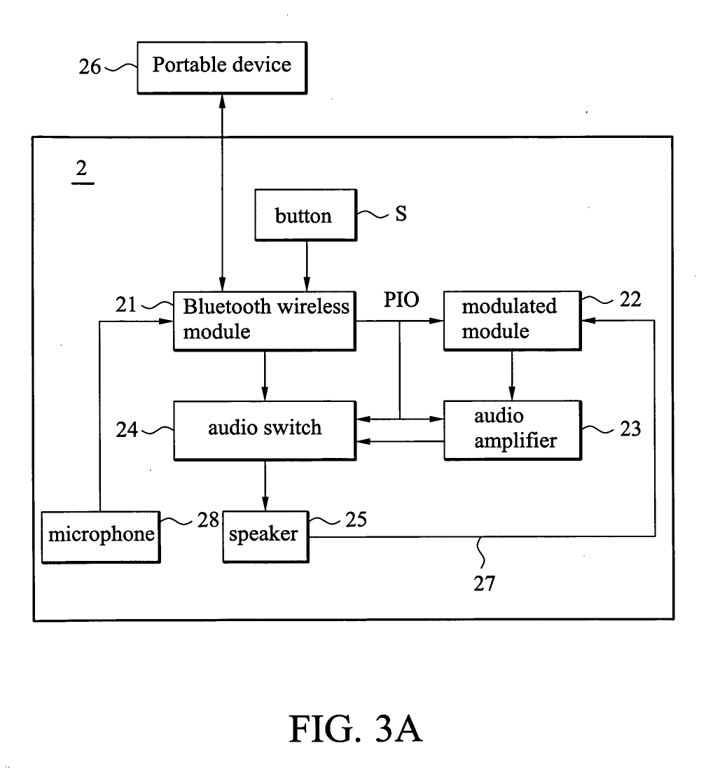

Referring to FIG. 2, a schematic diagram of a wireless headphone according to an embodiment of the invention. A wireless headphone 2 includes a Bluetooth wireless module 21 and a modulated module 22. The Bluetooth wireless module 21 is provided to receive a Bluetooth communication signal. The modulated module 22 is provided to receive a FM audio signal. Moreover, the Bluetooth wireless module 21 and the modulated module 22 are electrically connected. In addition, the wireless headphone 2 further includes an audio amplifier 23, an audio switch 24 and a speaker 25. The audio amplifier 23 adjusts the volume of the audio signal. The audio switch 24 can switch the FM audio signal or the Bluetooth communication signal. The speaker 25 outputs the sound generated from the audio switch 24 to the user.

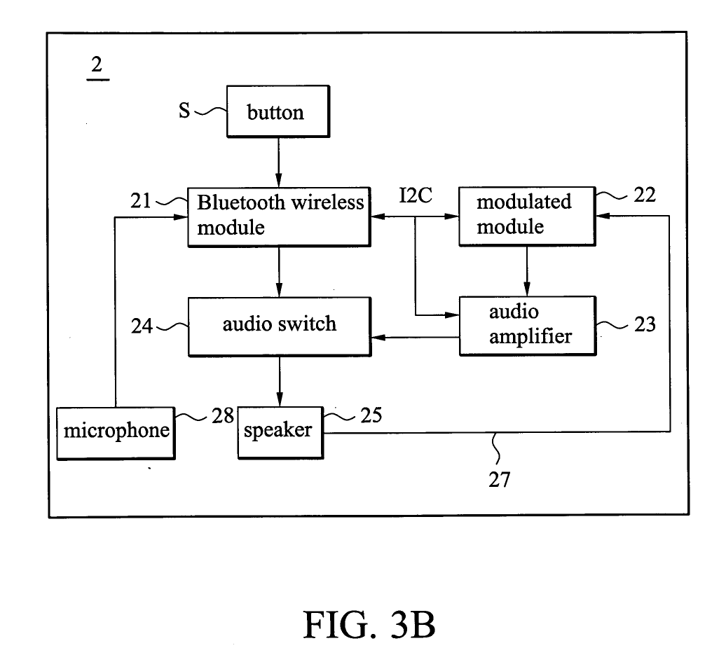

FIGS. 3A and 3B, FIG. 3A is a block diagram illustrating the switch function of the wireless headphone shown in FIG. 2, and FIG. 3B is a block diagram illustrating the FM function of the wireless headphone shown in FIG. 2. As shown in FIGS. 3A and 3B, the Bluetooth wireless module 21 includes a micro-controller and a cache (not shown in the figure). Accordingly, all programming control procedures of the wireless headphone 2 are first processed in the Bluetooth wireless module 21, and then the adjustment of volume and frequency is controlled, and selection between the Bluetooth communication signal or the FM audio signal is performed. Therefore, when the wireless headphone 2 receives the Bluetooth communication signal, the Bluetooth communication signal is processed by the Bluetooth wireless module 21 independently, and the sound, i.e. the signal, subsequently output through the speaker 25. Additionally, when the. FM audio signal is selected, through a programmable input/output (PIO) line interface, the modulated module 22, the audio switch 24, and the audio amplifier 23 can be activated simultaneously to receive the FM audio signal. When the volume and frequency of the wireless headphone 2 is adjusted, the frequency of the modulated module 22 and the volume of the audio amplifier 23 can be controlled and adjusted through an inter-integrated circuit (I2C) by the Bluetooth wireless module 21. As a result, without changing original Bluetooth communication structure, the wireless headphone 2 can provide the FM audio signal receiving function by only adding the modulated module 22, the audio amplifier 23, and the audio switch 24. The application of the product is then effectively improved. Moreover, when the modulated module 22 and the Bluetooth wireless module 21 are integrated, both of them share the same microprocessor and cache, and thus the manufacturing costs can be saved.

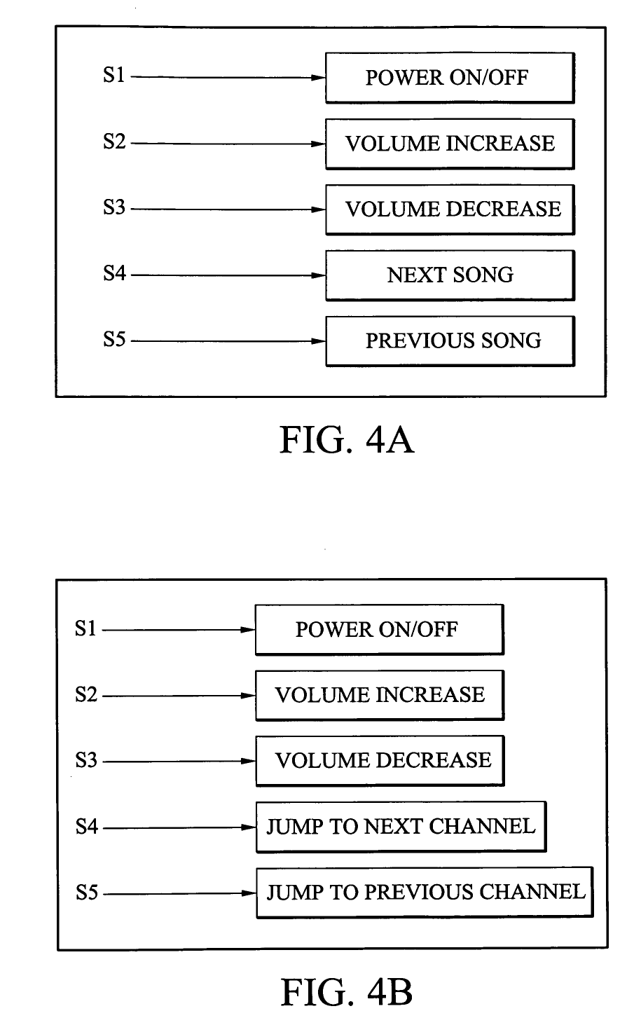

FIG. 4A is a descriptive drawing indicating the button function in the Bluetooth mode employed by the wireless headphone shown in FIG. 2, and FIG. 4B is a descriptive drawing indicating the button function in the FM mode employed by the wireless headphone shown in FIG. 2. The wireless headphone is provided with at least one button S, such as buttons S1˜S5, to drive the Bluetooth wireless module 21 to switch functions for the user. When the button S1 “POWER ON/OFF” is pressed by the user, the power switch accordingly is turned on. In the meantime, the wireless headphone 2 can execute the default Bluetooth function and immediately pair with the portable device 26 having the Bluetooth transmission function for communicating, such as a walkman or a cellular phone, etc. When the wireless headphone 2 is in the Bluetooth mode, each of the buttons is in accordance with a specific function respectively. For example, S2 and S3 are “VOLUME INCREASE” and “VOLUME DECREASE”, respectively; and S4 and S5 are “NEXT SONG” and “PREVIOUS SONG”, respectively.

In addition, assuming listening to the radio is required, a combination of the buttons may be provided according to the demands and requirements of the user. For example, when S2 and S3 are pressed together for 2 seconds, through a programmable input/output (PIO) line interface, the Bluetooth wireless module 21 then outputs a 3.3V voltage to simultaneously activate the modulated module 22, the audio amplifier 23, and the audio switch 24. Therefore, the audio switch 24 is switched from the default Bluetooth mode to the FM mode. The modulated module 22 uses a wire connected to the speaker 25 to be an antenna 27 for receiving an external FM sound source. The volume of the FM sound source processed by the modulated module 22 is adjusted in the audio amplifier 23, and then transmitted through the speaker 25 connected to the audio switch 24. Meanwhile, the function corresponding to S4 and S5 automatically changes to “JUMP TO NEXT CHANNEL” and “JUMP TO PREVIOUS CHANNEL”, respectively. When a desired channel is close to a displayed value, a fine-tune function for 0.05 MHz per step is provided by pressing S4 or S5 quickly, until the desired channel is received. Also, a simple and rapid channel scanning function is available by still-pressing the buttons for a longer time so that the forward/backward channel with stronger signals can be reached. The general functions of the remaining buttons S1˜S3 is similar to those described above, and thus will be omitted for simplicity. Moreover, for the wireless headphone 2, the numbers of the buttons S, the functions thereof, and the design of the combined buttons are not limited and can be increased or decreased according to the practical demands and requirements of designers for convenient operation.

As aforementioned above, the benefits of the wireless headphone 2 are not intended to be limited. The wireless headphone 2 can be paired with a cellular phone in advance. The next, the wireless headphone 2 stops the FM sound source and starts to ring when the cellular phone receives an external call during the period of listening to the FM sound source. In the meanwhile, when pressing the button S1, the user answers the call by using the microphone 28 of the wireless headphone 2 through the Bluetooth wireless module 21. When the conversation is over, the wireless headphone 2 switches back to the FM sound source and thus the missed calls can be prevented when listening to the FM sound source.

Specifically, the wireless headphone 2 of the invention has the capability of receiving Bluetooth sound sources as well as receiving FM sound sources without requirement of other devices so that any phone calls will not be missed when using the device. Therefore, the wireless headphone 2 has significantly and practicability improvement.

While the invention has been described by way of example and in terms of preferred embodiments, it is to be understood that the invention is not limited to the disclosed embodiments. To the contrary, it is intended to cover various modifications and similar arrangements as would be apparent to those skilled in the Art. Therefore, the scope of the appended claims should be accorded the broadest interpretation so as to encompass all such modifications and similar arrangements.

What is claimed is:

1. A wireless headphone comprising:
a wireless module for receiving a radio-communication signal; and
a modulated module electrically connected to the wireless module for receiving a FM audio signal.

2. The wireless headphone of claim 1, further comprising an audio amplifier electrically connected to the modulated module for adjusting a volume; and an audio switch electrically connected to the wireless module and the audio amplifier for switching the radio-communication signal and the FM radio signal.

3. The wireless headphone of claim 2, wherein the wireless module controls the switches of the modulated module, the audio amplifier and the audio switch through a programmable input/output line.

4. The wireless headphone of claim 1, wherein the wireless module controls the frequency of the modulated module through an inter-integrated circuit so as to control the volume of the audio amplifier.

5. The wireless headphone of claim 1, wherein the wireless module comprises a micro-controller and a cache shared with the modulated module.

6. The wireless headphone of claim 5, further comprising at least one button for controlling the wireless module.

7. The wireless headphone of claim 1, further comprising a speaker connected to the modulated module by a wire as an antenna of the modulated module.

8. A Bluetooth wireless headphone, comprising:
a Bluetooth wireless module configured to receive a Bluetooth communication signal; and
a modulated module configured to receive a FM audio signal and electrically connected to the Bluetooth wireless module.

9. The Bluetooth wireless headphone of claim 8, further comprising an audio amplifier electrically connected to the modulated module for adjusting an volume and an audio switch electrically connected to the Bluetooth wireless module for switching the FM audio signal and the Bluetooth communication signal.

10. The Bluetooth wireless headphone of claim 9, wherein the Bluetooth wireless module controls the switches of the modulated module, the audio amplifier and the audio switch through a programmable input/output line.

11. The Bluetooth wireless headphone of claim 8, wherein the Bluetooth wireless module controls the frequency of the modulated module and the volume of the audio amplifier through an inter-integrated circuit.

12. The Bluetooth wireless headphone of claim 11, wherein the Bluetooth wireless module comprises a micro-controller and a cache shared with the modulated module.

13. The Bluetooth wireless headphone of claim 8, further comprising a speaker connected to the modulated module by a wire.

14. The Bluetooth wireless headphone of claim 13, wherein the wire is an antenna of the modulated module.

15. The Bluetooth wireless headphone of claim 8, further comprising a microphone configured to respond an external call.

16. The Bluetooth wireless headphone of claim 8, wherein the Bluetooth wireless module is paired with a portable device capable of wireless transmission.

17. The Bluetooth wireless headphone of claim 16, wherein the portable device is a cellular phone or walkman.

18. The Bluetooth wireless headphone of claim 8, further comprising at least one button, wherein the button controls the Bluetooth wireless module.
